(19) United States
(12) Patent Application Publication
(10) Pub. No.: US 2015/0052141 A1
(43) Pub. Date: Feb. 19, 2015

(54) ELECTRONIC DEVICE AND METHOD FOR TRANSMITTING FILES

(71) Applicant: HON HAI PRECISION INDUSTRY CO., LTD., New Taipei (TW)

(72) Inventors: JEN-HSIUNG CHARNG, New Taipei (TW); CHI-LING LIN, New Taipei (TW); CHIEN-WEI LEE, New Taipei (TW); I-CHEN LEE, New Taipei (TW)

(21) Appl. No.: 14/460,724

(22) Filed: Aug. 15, 2014

(30) Foreign Application Priority Data
Aug. 19, 2013 (CN) 2013103601547

(51) Int. Cl. G06F 17/30; H04L 29/08

(52) U.S. Cl. CPC G06F 17/3007; H04L 67/10
USPC 707/737

(57) ABSTRACT

Method of transmitting ancillary files to users in support of main files includes acquiring information as to what is read by users within a predetermined period of time. According to the information as to what is read by users, the users are classified into groups using a clustering method. A current user is determined and a group that comprises the current user is determined. Target files read by the other users in the determined group are transmitted for the current user.

### CROSS-REFERENCE TO RELATED APPLICATIONS

This application claims priority to Chinese Patent Application No. 201310360154.7 filed on Aug. 19, 2013 in the China Intellectual Property Office, the contents of which are incorporated by reference herein.

### FIELD

Embodiments of the present disclosure relate to data management and file transmissions.

### BACKGROUND

Information, such as for example new articles, may be provided over the Internet. When a user reads a news article over the Internet, the user may want to read other related news articles. Therefore, there is a need to provide the other related news articles to the user.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure. Moreover, in the drawings, like reference numerals designate corresponding parts throughout the several views.

FIG. 1 is a diagrammatic view of one embodiment of an electronic device including a transmission system.

FIG. 2 is a diagrammatic view of one embodiment of function modules of the transmission system in the electronic device of FIG. 1.

FIG. 3 illustrates a flowchart of one embodiment of a method for transmitting files in the electronic device of FIG. 1.

FIG. 4 illustrates a diagrammatic view of a matrix used in the transmission system.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure.

The present disclosure, including the accompanying drawings, is illustrated by way of examples and not by way of limitation. It should be noted that references to “an” or “one” embodiment in this disclosure are not necessarily to the same embodiment, and such references mean “at least one.”

Furthermore, the term “module”, as used herein, refers to logic embodied in hardware or firmware, or to a collection of software instructions, written in a programming language, such as, Java, C, or assembly. One or more software instructions in the modules can be embedded in firmware, such as in an EPROM. The modules described herein can be implemented as either software and/or hardware modules and can be stored in any type of non-transitory computer-readable medium or other storage device. Some non-limiting examples of non-transitory computer-readable media include CDs, DVDs, BLU-RAY, flash memory, and hard disk drives.

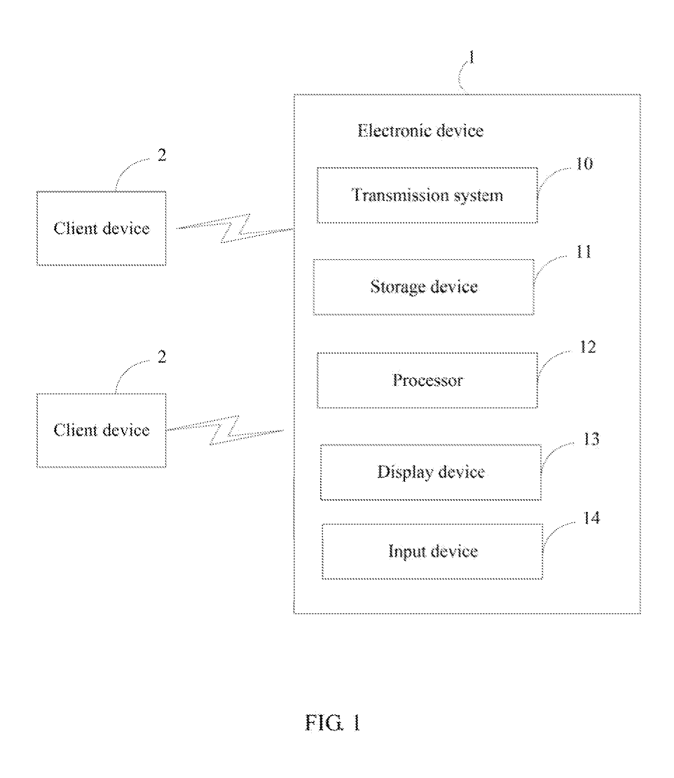

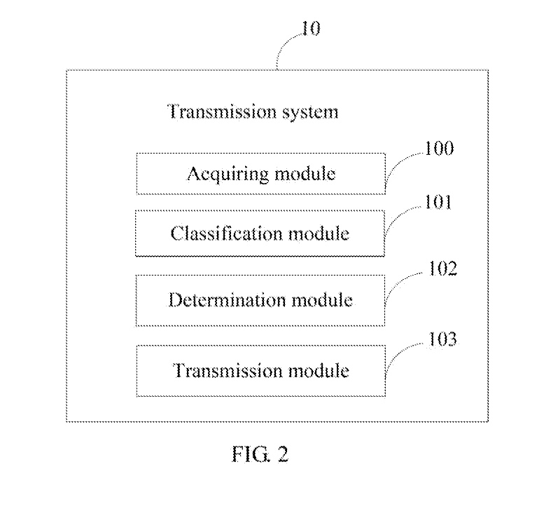

FIG. 1 illustrates a diagrammatic view of one embodiment of an electronic device. Depending on the embodiment, the electronic device 1 includes a transmission system 10. The electronic device 1 is connected to a plurality of client devices 2. A user can read files on one of the client devices 2. The electronic device 1 includes, but is not limited to, a storage device 11, at least one processor 12, a display device 13, and an input device 14. The electronic device 1 can be a server, a computer, a smart phone, a personal digital assistant (PDA), or other electronic device. It should be understood that FIG. 2 illustrates only one example of the electronic device that can include more or fewer components than illustrated, or have a different configuration of the various components in other embodiments.

When a user reads a file on one of the client devices 2, the transmission system 10 can determine other files related to the read file according to predetermined rules, and transmit the related files to the client device 2 for the user.

In at least one embodiment, the storage device 11 can include various types of non-transitory computer-readable storage mediums, such as a hard disk, a compact disc, a digital video disc, or a tape drive. The display device 13 can display images and videos, and the input device 14 can be a mouse, a keyboard, or a touch panel.

FIG. 2 is a diagrammatic view of one embodiment of function modules of the transmission system. In at least one embodiment, the transmission system can include an acquiring module 100, a classification module 101, a determination module 102, and a transmission module 103. The function modules 100, 101, 102, and 103 can include computerized codes in the form of one or more programs, which are stored in the storage device 11. The at least one processor executes the computerized codes to provide functions of the function modules 100-103.

The acquiring module 100 acquires reading information of users within a predetermined period. In at least one embodiment, the reading information of the users includes keyword characteristic values of predetermined keywords corresponding to each of the users, and reading characteristic values which represents reading habits corresponding to each of the users.

The acquiring module 100 acquires a title of each read file of the users within the predetermined period, and determines the keywords from the title of each read file as being the predetermined keywords. The acquiring module 100 calculates a frequency of each of the predetermined keywords in read files of the specified user. The calculated frequency of each of the predetermined keywords is determined to be a keyword characteristic value of each of the predetermined keywords corresponding to the specified user. For example, the predetermined keywords can include three keywords, namely A, B and C. If a frequency of A in read files of a specified user is 20, a keyword characteristic value of A which corresponds to the specified user is 20.

The reading characteristic values include, but are not limited to, an average daily reading duration, the time(s) of the day when reading is done, an average reading speed, an average number of reading files and a total reading duration of each of the users.

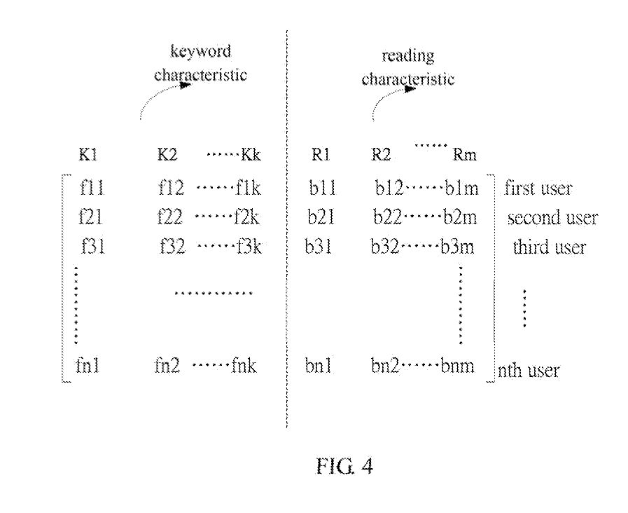

According to the reading information of users, the classification module 101 classifies the users into groups using a clustering method. In some embodiments, a user is classified to a single group, and in other embodiments, a user can be classified into more than one group. In at least one embodiment, the clustering method uses an expectation-maximization algorithm. The classification module 101 establishes a matrix according to the reading information of the users. The matrix is regarded as an input of the expectation-maximization algorithm. For example, as shown in FIG. 4, there are a number k of keyword characteristic values, a number m of reading characteristic values, and a number n of users which are included in the matrix. One row of the matrix corresponds to reading information of one user.

In other embodiments, the classification module 101 determines whether a classification result of the users is appropriate by calculating a sum of squares for error (SSE) of each of the groups based on the above mentioned keyword characteristic values and reading characteristic values. When a total sum of an SSE of a group is greater than or equal to a predetermined value, the classification module 101 determines that a classification result of users in the group is inappropriate, and reclassifies the users into another group or other groups. When a total sum of a SSE of a group is less than the predetermined value, the classification module 101 determines that a classification result of users in the group is appropriate.

The determination module 102 determines a current user and determines a group that includes the current user.

The transmission module 103 transmits target files for the current user. In at least one embodiment, the transmission module 103 determines the target files according to what is read by the other users in the determined group.

In other embodiments, the acquired reading information is updated after the predetermined period, and the groups can be updated according to the updated reading information of users.

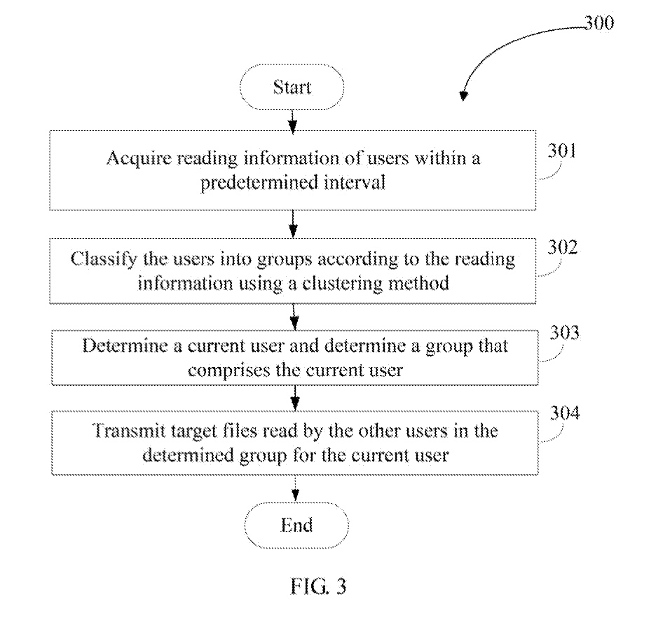

Referring to FIG. 3, a flowchart is presented in accordance with an example embodiment. The example method 300 is provided by way of example, as there are a variety of ways to carry out the method. The method 300 described below can be carried out using the configurations illustrated in FIGS. 1, and 2, for example, and various elements of these figures are referenced in explaining example method 300. Each block shown in FIG. 3 represents one or more processes, methods, or subroutines carried out in the exemplary method 300. Additionally, the illustrated order of blocks is by example only and the order of the blocks can change. The exemplary method 300 can begin at block 301. Depending on the embodiment, additional steps can be added, others removed, and the ordering of the steps can be changed.

In block 301, an acquiring module acquires reading information of users within a predetermined period. In at least one embodiment, the reading information of the users includes keyword characteristic values of predetermined keywords corresponding to each of the users, and reading characteristic values which represents reading habits corresponding to each of the users.

The acquiring module acquires a title of each read file of the users within the predetermined period, and determines keywords from the title of each read file to be the predetermined keywords. The acquiring module calculates a frequency of each of the predetermined keywords in read files of the specified user. The calculated frequency of each of the predetermined keywords is determined to be a keyword characteristic value of each of the predetermined keywords corresponding to the specified user.

The reading characteristic values include an average daily reading duration, the time(s) of the day when reading is done, an average reading speed, an average number of reading files and a total reading duration of each of the users.

In block 302, according to the reading information, a classification module classifies the users into groups using a clustering method. In some embodiments, a user is classified to a single group, and in other embodiments, a user can be classified into more than one group. In at least one embodiment, the clustering method uses an expectation-maximization algorithm. The classification module 101 establishes a matrix according to the reading information of the users. The matrix is regarded as an input of the expectation-maximization algorithm.

In block 303, a determination module determines a current user and determines a group that includes the current user.

In block 304, a transmission module transmits target files for the current user. In at least one embodiment, the transmission module 103 determines the target files according to what read by the other users in the determined group.

In other embodiments, the acquired reading information is updated after the predetermined period, and the groups are updated according to the updated reading information of users.

It should be emphasized that the above-described embodiments of the present disclosure, including any particular embodiments, are merely possible examples of implementations, set forth for a clear understanding of the principles of the disclosure. Many variations and modifications can be made to the above-described embodiment(s) of the disclosure without departing substantially from the spirit and principles of the disclosure. All such modifications and variations are intended to be included herein within the scope of this disclosure and protected by the following claims.

What is claimed is:

1. A computer-implemented method for transmitting files using an electronic device, the method comprising:
acquiring reading information of users within a predetermined period;
classifying the users into groups according to the reading information using a clustering method;
determining a current user and determining a group that comprises the current user; and
transmitting target files read by other users in the determined group for the current user.

2. The method according to claim 1, wherein the reading information of the users comprises keyword characteristic values of predetermined keywords corresponding to each of the users, and reading characteristic values representing reading habits corresponding to each of the users.

3. The method according to claim 2, further comprising:
acquiring a title of each read file of the users within the predetermined period; and
determining keywords of the title of each read file to be the predetermined keywords.

4. The method according to claim 3, wherein keyword characteristic values of the predetermined keywords corresponding to a specified user are determined by:
calculating a frequency of each of the predetermined keywords in read files of the specified user; and
determining the calculated frequency of each of the predetermined keywords to be a keyword characteristic value of each of the predetermined keywords corresponding to the specified user.

5. The method according to claim 2, wherein the reading characteristic values comprise an average daily reading duration, the times of the day when reading is done, an average reading speed, an average number of reading files and a total reading duration of each of the users.

6. The method according to claim 1, wherein the clustering method uses an expectation-maximization algorithm.

7. An electronic device, comprising:
a processor; and
a storage device that stores one or more programs, when executed by the at least one processor, cause the at least one processor to:
acquire reading information of users within a predetermined period;
classify the users into groups according to the reading information using a clustering method;
determine a current user and determine a group that comprises the current user; and
transmit target files read by other users in the determined group for the current user.

8. The electronic device according to claim 7, wherein the reading information of the users comprises keyword characteristic values of predetermined keywords corresponding to each of the users, and reading characteristic values representing reading habits corresponding to each of the users.

9. The electronic device according to claim 8, wherein the at least one processor is caused to:
acquire a title of each read file of the users within the predetermined period; and
determine keywords of the title of each read file to be the predetermined keywords.

10. The electronic device according to claim 9, wherein keyword characteristic values of the predetermined keywords corresponding to a specified user are determined by:
calculating a frequency of each of the predetermined keywords in read files of the specified user; and
determining the calculated frequency of each of the predetermined keywords to be a keyword characteristic value of each of the predetermined keywords corresponding to the specified user.

11. The electronic device according to claim 8, wherein the reading characteristic values comprise an average daily reading duration, the times of the day when reading is done, an average reading speed, an average number of reading files and a total reading duration of each of the users.

12. The electronic device according to claim 7, wherein the clustering method uses an expectation-maximization algorithm.

13. A non-transitory storage medium having stored thereon instructions that, when executed by a processor of an electronic device, causes the processor to perform a method for transmitting files, wherein the method comprises:
acquiring reading information of users within a predetermined period;
classifying the users into groups according to the reading information using a clustering method;
determining a current user and determining a group that comprises the current user; and
transmitting target files read by other users in the determined group for the current user.

14. The non-transitory storage medium according to claim 13, wherein the reading information of the users comprises keyword characteristic values of predetermined keywords corresponding to each of the users, and reading characteristic values representing reading habits corresponding to each of the users.

15. The non-transitory storage medium according to claim 14, wherein the method further comprises:
acquiring a title of each read file of the users within the predetermined period; and
determining keywords of the title of each read file to be the predetermined keywords.

16. The non-transitory storage medium according to claim 15, wherein keyword characteristic values of the predetermined keywords corresponding to a specified user are determined by:
calculating a frequency of each of the predetermined keywords in read files of the specified user; and
determining the calculated frequency of each of the predetermined keywords to be a keyword characteristic value of each of the predetermined keywords corresponding to the specified user.

17. The non-transitory storage medium according to claim 14, wherein the reading characteristic values comprise an average daily reading duration, the times of the day when reading is done, an average reading speed, an average number of reading files and a total reading duration of each of the users.

18. The non-transitory storage medium according to claim 13, wherein the clustering method uses an expectation-maximization algorithm.
